(19) United States
(12) Patent Application Publication
(10) Pub. No.: US 2010/0285424 A1
(43) Pub. Date: Nov. 11, 2010

(54) DENTAL APPLICATOR DEVICE

(76) Inventors: Paul A. Burgio, St. Paul, MN (US); Wayne K. Dunshee, Maplewood, MN (US); Raymond P. Johnston, Lake Elmo, MN (US)

Correspondence Address: 3M INNOVATIVE PROPERTIES COMPANY, PO BOX 33427, ST. PAUL, MN, 55133-3427, US

(21) Appl. No.: 12/664,207

(22) PCT Filed: Jan. 28, 2009
(86) PCT No.: PCT/US2009/032211

§ 371 Date: Dec. 11, 2009

Related U.S. Application Data
(60) Provisional application No. 61/024,740, filed on Jan. 30, 2008.

(51) Int. Cl. A61C 19/06

(52) U.S. Cl. 433/80; 433/25; 433/215

(57) ABSTRACT

A dental applicator device is disclosed. Generally, the dental applicator device includes a trough comprising a first wall, a second wall, and a floor, wherein at least one of the first wall, second wall, and floor comprises a contact surface, wherein at least a portion of the contact surface comprises a reticulated foam material. Methods of applying a dental agent to a target surface of a subject's dentition are also disclosed. Generally, the methods include providing a dental applicator device that includes a trough having a first wall, a second wall, and a floor, wherein at least one of the first wall, second wall, and floor comprises a contact surface, wherein at least a portion of the contact surface comprises a reticulated foam material, and a dental agent disposed in at least a portion of the trough; applying the dental applicator device to at least a portion of the subject's dentition for a time effective to transfer an effective amount of the dental agent to at least a portion of the target surface; and removing the dental applicator device.

### CROSS-REFERENCE TO RELATED APPLICATIONS

This application claims the benefit of U.S. Provisional Patent Application No. 61/024,740, filed Jan. 30, 2008.

### BACKGROUND

Dental professionals often use liquid, foam, gelatinous, or paste materials when providing dental care. Such materials include, for example, dental varnishes, polishes, fillings, medications, and prophylactic remedies. Often, such materials may be applied using a dental tray in which a trough is generally configured to fit over at least a portion of a subject's dental arch. A dental treatment agent is added to the device and the device is fitted over the subject's teeth. The dental agent is dispersed by applying pressure—e.g., bite pressure—to the tray. The dental agent coats the teeth and the device (with excess dental agent) is removed.

Many such dental trays are constructed of open cell and/or closed cell foam materials. Often, the application pressure may cause excess dental agent to escape from the device and be deposited onto one or more surfaces of the subject's oral cavity. If the dental agent possesses, for example, an unpleasant taste, odor, or feel, the dental treatment may cause the subject to have an unpleasant experience. The magnitude of taste perception may be generally related to the amount of material—e.g., dental agent—in contact with the subject's tongue, whereas the magnitude of the smell perception may be generally related to the amount of material in contact with the oral cavity. One way to decrease discomfort associated with certain dental treatments would be to decrease the likelihood and extent to which dental agent escapes the applicator and contacts the subject's oral cavity and, in particular, the subject's tongue.

### SUMMARY

In one aspect, the invention includes a dental applicator device. Generally, the dental applicator device includes a trough that includes a first wall, a second wall, and a floor, wherein at least one of the first wall, second wall, and floor includes a contact surface, wherein at least a portion of the contact surface includes a reticulated foam material.

In some embodiments, the dental applicator device can include a handle. In other embodiments, the dental applicator device can include a terminal wall that connects the first wall and the second wall at either or both ends of the trough. In still other embodiments, the dental applicator device can include a dental agent.

In another aspect, the invention provides a method of applying a dental agent to a target surface of the dentition of a subject. Generally, the method includes providing a dental applicator device that includes a trough comprising a first wall, a second wall, and a floor, wherein at least one of the first wall, second wall, and floor includes a contact surface, wherein at least a portion of the contact surface includes a reticulated foam material, and a dental agent disposed in at least a portion of the trough; applying the dental applicator device to at least a portion of the subject's dentition for a time effective to transfer an effective amount of the dental agent to at least a portion of the target surface; and removing the dental applicator device.

In alternative embodiments, the method includes applying a dental agent to both dental arches of the subject. One such embodiment employs a single device that includes two troughs, one for applying dental agent to at least a portion of each of the subject's dental arches. A second embodiment includes using two devices, one for applying dental agent to the upper arch and a second device for applying dental agent to the lower arch.

In some embodiments, the time effective to transfer an effective amount of the dental agent to at least a portion of the target surface is from about one second to about ten minutes.

In some embodiments the subject is an animal such as, for example, a human, a companion animal, a livestock animal, or an exotic animal.

### BRIEF DESCRIPTION OF THE DRAWING

FIG. 1 is a top view of a dental applicator device.

FIG. 2A is a top perspective view of an alternative embodiment of the dental applicator device.

FIG. 2B is a top perspective view of the dental applicator device shown in FIG. 2A after being formed to fit the subject's dental arch.

### DETAILED DESCRIPTION OF ILLUSTRATIVE EMBODIMENTS

The present invention relates to a device for providing dental treatment to a subject. In one aspect the invention includes a device that can be used to apply a dental agent to some or all of a subject's teeth. The device includes one or more contact surfaces constructed from a reticulated foam material. In use, the device is fitted over the subject's teeth and the contact surface typically contacts the surface of the subject's teeth, including one or more target surfaces to which the dental agent is intended to be applied. In this way, dental agent provided in the device can contact the target surface(s). Because the contact surface of the device includes reticulated foam material, a substantial portion of excess dental agent is retained in the device rather than being expelled from the device and left in the subject's mouth, where it is typically either swallowed or expectorated. Thus, the device can reduce the likelihood and/or extent that a subject has an unpleasant experience resulting from application of the dental agent.

As used herein, the following terms shall have the indicated meanings:

“Dentition” refers to at any portion of one or more teeth of a subject. Thus, dentition may refer to a localized target area of a single tooth, target areas of a plurality of teeth, an entire dental arch, and/or a full set of teeth of a subject.

The term “comprises” and variations thereof do not have a limiting meaning where these terms appear in the description and claims.

As used herein, “a,” “an,” “the,” “at least one,” and “one or more” are used interchangeably. Thus, for example, a dental application device that includes a dental agent can be interpreted to mean that the dental application device includes “one or more” dental agents.

The term “and/or” means one or all of the listed elements or a combination of any two or more of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

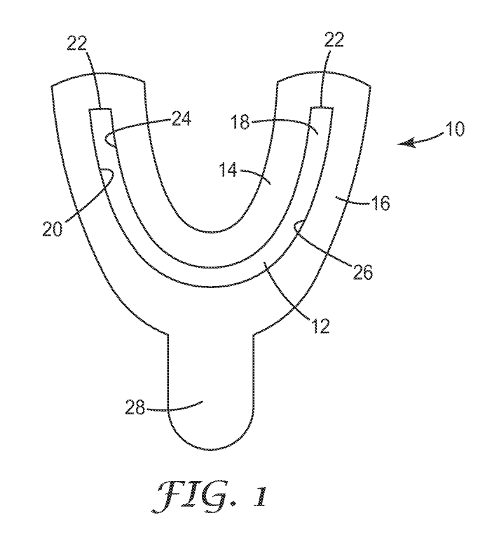

Referring to FIG. 1, the device (10) generally includes a trough (12) into which the subject's teeth will typically fit during use. The trough (12) is defined by a first wall (14), a second wall (16), and a floor (18). At least one of the first wall (14), second wall (16), and a floor (18) includes a contact surface (20) that includes a reticulated foam material. When the device (10) is applied, at least a portion of the contact surface (20) will contact at least a portion of the subject's dentition and/or gums.

As used herein, the term “floor” is used to describe the surface at the bottom of the trough when the device is oriented for applying the device to the upper dental arch of a subject in the standing position, even if any particular use of the device calls for applying the device to, for example, the lower dental arch or either dental arch of a subject in a full or partially reclined position. Thus, use, of the term “floor” is not intended to imply any limits on the useful orientation of the device in any particular application.

Generally, the trough (12) may be constructed to fit over the teeth of a subject so that the device (10) may be applied to at least a portion of the dental arch. Generally, application of the dental agent includes fitting the device (10) over a portion of the subject's dentition for an amount of time effective to permit dental agent in the device (10) to be transferred from the device (10) to a target surface of the subject's dentition and/or gums, and removing the device.

Prior to use, dental agent is added to the device (10). The dental agent may be in any suitable formulation for application to the dentition and/or gums of a subject. Suitable formulations can include, for example, a foam, a coating, a liquid (e.g., a solution), a gel, a paste, or the like. In some cases, a user may load the device (10) by adding dental agent to one or more portions of the device (10) prior to applying the device (10) to a subject. The dental agent may be added to any portion of the device (10) suitable for delivering an effective amount of the dental agent to the subject. For example, dental agent may be added to one or more surfaces of the trough (12) including, for example, the floor (18). The identity and character of the dental agent, the type and character of the formulation, and the material from which the area of the device to which the dental agent is added is fabricated may determine, in part, whether the dental agent remains disposed on the surface of the trough (12) or is absorbed into the trough (12). In other cases, the device may be loaded with dental agent prior to packaging so that it is ready to use without requiring the user to add dental agent.

Dental agent foams, coatings, solutions, pastes, gels, and the like are well known to those skilled in the art. In general, the dental agent can include an active agent and a pharmaceutically acceptable carrier. In some embodiments, the dental formulation can be a foam such as, for example, one of the foams described in International Patent Publication No. WO 2007/079069; U.S. Pat. No. 4,770,634; U.S. Pat. No. 5,073,363; and U.S. Pat. No. 6,251,369.

Generally, a suitable active agent may offer a beneficial or therapeutic effect on the health, integrity, and/or appearance of oral hard and/or soft tissues. Suitable active agents can include, for example, fluoride sources, antimicrobial agents, antifungal agents, biologically active materials, oxygenating agents, bleaches and/or whiteners, anticaries agents, remineralizing agents, agents for treating xerostomia, anesthetics, desensitizing agents, clotting agents, wetting agents, breath fresheners, varnishes, polishes, and combinations thereof. A dental agent can include any combination of two or more active agents, if desired.

Thus, a dental agent can include a fluoride source such as, for example, sodium fluoride, stabilized stannous fluoride, amine fluorides, and the like. The fluoride can be provided in concentrations of from 0.05 to 15.0 weight percent. A dental agent can include a combination of fluoride sources, if desired.

In other embodiments, a dental agent can include an antimicrobial agent. Suitable antimicrobial agents include, for example, quaternary ammonium compounds such as cetylpyridinium chloride, domiphen bromide, benzethonium chloride and the like; antibiotics and related drugs such as, for example, nitroimidazoles (metronidazole, etc.), tetracyclines, penicillins, clindamycin, spiramycin, nystatin, amphotericin, erythromycin, and the like; essential oils such as, for example, thymol, eucalyptol, menthol, methyl salicylate, and the like; metal salts such as, for example, mercurials, zinc salts, aluminum salts, and the like; other treatment compounds such as, for example, chlorhexidine, alexidine, hexetridine, IRGASAN DP300, salicylanilides, and the like. Suitable antimicrobial film forming compositions are described, for example, in International Patent Publication No. WO 2006/098896. A dental agent can include a combination of antimicrobial agents, if desired.

In certain embodiments, a dental agent can include a biologically active material such as, for example, a growth hormone and/or other compound or composition that can enhance or stimulate tissue growth, regrowth, and/or healing. A dental agent can include a combination of biologically active materials, if desired.

In certain embodiments, a dental agent can include an oxygenating agent such as, for example, sodium perborate, urea peroxide, stabilized hydrogen peroxide, and the like. A dental agent can include a combination of oxygenating agents, if desired.

In certain embodiments, a dental agent can include a dental bleach and/or whitener such as, for example, a peroxide. Suitable dental whitening compositions are described, for example, in International Patent Publication No. WO 2004/069215. A dental agent can include a combination of dental bleaches and/or whiteners, if desired.

In certain embodiments, a dental agent can include a desensitizing agent such as, for example, hydroxyapatite, formaldehyde, a soluble oxalate, a potassium salt (e.g., potassium fluoride), and the like. A dental agent can include a combination of desensitizing agents, if desired.

In certain embodiments, a dental agent can include a dental varnish. Suitable dental varnishes are described, for example, in U.S. Pat. No. 7,264,882; U.S. Pat. No. 5,330,746; and in U.S. Patent Publication No. US 2006/0004120. A dental agent can include a combination of dental varnishes, if desired.

In certain embodiments, a dental agent can include an anticaries agent such as, for example, xylitol, chlorhexidine, triclosan. A dental agent can include a combination of anticaries agents, if desired.

In certain embodiments, a dental agent can include a remineralizing agent such as, for example, CaHPO₄ (calcium phosphate (dibasic)). A dental agent can include a combination of remineralizing agents, if desired.

A dental agent can further include any suitable additive. As used herein, “additive” refers to a material that does not offer a substantial beneficial or therapeutic effect on the health, integrity, and/or appearance of oral hard and/or soft tissues, but instead primarily affects the sensory, chemical or physical character of the dental agent. Suitable additives include, for example, gelling agents, humectants, surfactants, emulsifiers, viscosity modifiers, thixotropes, fillers, polyols, buffering agents, acidifying agents, colorings, chlorophyll compounds, flavoring agents, preservatives, co-solvents, stabilizers, sweeteners, dyes, and any combination thereof.

Thus, in some embodiments, a dental agent can include, for example, a humectant. Suitable humectants include, for example, sorbitol, glycerin, other edible polyhydric alcohols, natural or synthetic gums conventionally used as hardening control agents, binders, and combinations thereof.

In some embodiments, a dental agent can include one or more suitable flavorings and/or fragrances. Such additives include, for example, organic acids, esters, and aldehydes that are both safe and can provide a desired flavor or scent. Suitable flavorings include, for example, flavoring oils such as, for example, oil of spearmint, peppermint, wintergreen, sassafras, clove, sage, eucalyptus, marjoram, cinnamon, lemon, orange, and methyl salicylate. Suitable sweeteners include, for example, sucrose, lactose, maltose, dextrose, levulose, sorbitol, xylitol, d-tryptophan, dihydrochalcones, sodium cyclamate, perillartine, APM (aspartyl phenyl alanine, methyl ester), saccharine, and the like. A dental agent can include any combination of scents, flavorings, and/or sweeteners, if desired.

The device can be designed to have any form suitable for delivering an effective amount of dental agent to one or more target surfaces. FIG. 1 shows one embodiment in which the device (10) is constructed in the form of an arched trough. Such an embodiment should require little or no shaping of the device in order to apply the device to a portion of a subject's dentition. The device (10) as shown in FIG. 1 includes a first wall (14) and a second wall (16). Each of the first wall (14) and the second wall (16) includes a medial surface, (24) and (26), respectively. Between the first wall (14) and second wall (16) is a trough (12) designed to accept a portion of the subject's dentition when the device is applied to the subject.

In the embodiment shown in FIG. 1, the entire device (10) is constructed of a reticulated foam material. Thus, any one or more of the first wall medial surface (26), second wall medial surface (26), or floor (18) can serve as a contact surface (20). The contact surface (20) contacts at least a portion of the subject's dentition when the device (10) is applied during use. The reticulated foam material of the contact surface can capture excess dental agent. That is, once the device (10) is applied to a subject's dentition and an effective amount of dental agent is transferred to a target surface, it is expected that excess dental agent will be present. When certain current applicator devices are used, excess dental agent may ooze, flow, or otherwise escape from the device to a non-target portion of the subject's oral cavity. The dental agent may possess an unpleasant taste, odor, and/or feel and, therefore, uncontrolled excess dental agent can cause an unpleasant experience for the subject. In contrast, the reticulated foam material of the contact surface (20) can capture a greater amount of excess dental agent in the open cells of the reticulated foam structure than, for example, closed cell or open cell foam materials. In this way, less excess dental agent is available to escape during use and/or removal of the device (10). Thus, applying a dental agent using the device (10) can reduce the likelihood and/or extent of the subject's exposure to unpleasant taste, odor, and/or feel of excess dental agent. Accordingly, the device (10) can decrease the likelihood and extent of certain unpleasant experiences associated with dental treatments that include applying a dental agent.

The embodiment of the device (10) shown in FIG. 1 includes a terminal wall (22) at each end of the trough (12). Such an embodiment may fit over a subject's entire dental arch. The terminal walls (22) may further help control excess dental agent by forming a barrier that decreases the likelihood and extent that excess dental material escapes the trough (12).

In other embodiments, however, the device may not necessarily include terminal walls. Such embodiments may be desired, for example, for delivering dental agent to a target surface having a limited surface area. In such cases, a smaller device that is configured to fit over only a portion of a subject's dental arch and, therefore, may lack terminal walls may improve the level of comfort experienced by the subject during use of the device.

The embodiment shown in FIG. 1 also includes a handle (28). The handle (28) may be gripped to ease placement and/or removal of the device (10) during use.

The device also may optionally include a layer of supportive material adhered, affixed, or otherwise disposed on a portion of the device in order to lend structural support. The supportive material may be disposed on any portion of the device that will not interfere with positioning the device on a portion of a subject's dentition.

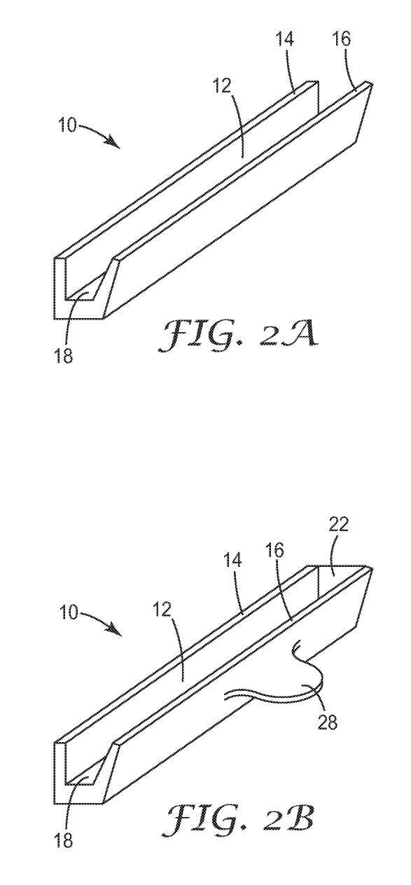

As noted above, the embodiment shown in FIG. 1 is constructed to form an arched trough. In certain alternative embodiments, the trough may not necessarily be arched to the extent shown in the embodiment of FIG. 1. In one embodiment, for example, the device may be constructed to form a generally linear trough, shown in FIG. 2A. The device (10) in this embodiment includes a trough (12) defined by a first wall (14), a second wall (16) and a floor (18). When applied to a subject's dentition, the device (10) may be shaped to fit the curvature of the subject's dental arch. This embodiment also may optionally include a handle (28) and/or a terminal wall (22) at one or both ends of the trough (12), as shown in FIG. 2B.

The embodiment of the device shown in FIG. 1 includes a single trough in one surface of the device. Such a device may be used to apply a dental agent to all or a portion of a subject's dental arch. If application of the dental agent to all or a portion of both dental arches of a subject is desired, the device may be reused to apply the dental agent to the subject's second dental arch. The device may be reloaded with dental agent, if necessary; however, reloading may not always be necessary to apply the dental agent to the second dental arch.

In certain embodiments, the device can include a second trough constructed and configured to receive teeth of the subject's second dental arch. Using such an embodiment, dentition of both dental arches may be treated simultaneously using a single applicator device.

Again, as noted above, the entire device shown in FIG. 1 is constructed of a reticulated foam material. However, in certain embodiments, at least a portion of the device may be constructed from other materials. One example of such an embodiment can include a core structure that generally possesses the desired form of the device and supports one or more sections of contact surface constructed, at least in part, from a reticulated foam material.

In such embodiments, the core structure may be constructed from any suitable orally safe base material. Such materials may be generally inert toward the dental agent and/or the subject's saliva. Suitable materials can include a polymeric material such as, for example, polypropylene, polyethylene, polytetrafluoroethylene, polyethylene terephthalate, polyacrylamide, polybutylene terephthalate, polyvinyl chloride, ethylene vinyl acetate, polyvinyl fluoride, polyurethane, cellulosic polymers, polystyrene, a nylon, and combinations thereof. Other suitable materials can include, for example, metals and metal alloys.

At least the contact surface of the device is constructed from reticulated foam material. Reticulated foam materials may be formed from open cell foam materials through the post process of reticulation, which removes window membranes of cells in the foam, leaving only the skeletal structure of the foam intact. Because the window membranes are removed in a reticulated foam, a greater portion of the volume of a reticulated foam is available for capturing and retaining compared to open cell and closed cells foams.

Reticulation may be performed using, for example, thermal or chemical methods. Thermal methods can include placing a bun of foam into a vacuum pressure vessel. The vessels may be evacuated, and then filled with an explosive gas mixture. When the gas is ignited, a controlled flame front is passed through the foam, melting the window membranes and leaving the skeletal structure of the foam intact. Chemical methods of reticulation can include, for example, running a loaf of foam through a caustic bath at a controlled temperature, concentration, and duration. The caustic solution can attack and dissolve the window membranes, leaving only the skeletal structure of the foam. The reticulated foam may then be washed, rinsed, and dried.

The contact surface may include a reticulated foam material fabricated from any suitable polymeric material such as, for example, polyester polyurethanes, polyether polyurethanes, polyimides, and certain thermoset plastic resins. In one particular embodiment, the reticulated foam is fabricated from a polyester polyurethane.

The reticulated foam may have any suitable porosity. Porosity of reticulated foams may be measured by the number of pores per lineal inch (ppi); porosity generally increases as the number of pores per inch decreases. Typical reticulated foams can have a porosity of from about ten to more than one hundred pores per inch. Less porous reticulated foams—i.e., those with a greater number of pores per inch—may possess a softer feel and, therefore, devices constructed from high-ppi reticulated foams may be more comfortable. The contact surface may be constructed from a reticulated foam material having a porosity of, for example, from about 10 ppi to about 100 ppi. In certain embodiments, the reticulated foam material possesses a porosity of from about 25 ppi to about 50 ppi. In one particular embodiment, the reticulated foam has a porosity of from about 35 ppi to about 45 ppi. In some embodiments, an expressly recited porosity may represent an average ppi of the reticulated foam. In other embodiments, an expressly recited porosity may represent a minimum ppi of the reticulated foam.

In embodiments such as those shown in FIG. 1 where the entire device is constructed of a reticulated foam material, the device—and, therefore, the reticulated foam material—may have any suitable thickness. A thickness may be considered suitable if it is sufficient to provide contact between at least a portion of the device and a target surface. Thus, it may not be necessary for the device to provide contact along the entire length of a tooth, for example. The device need only be sufficiently thick so that when the device is applied, at least a portion of the device contacts the desired target surface.

In some embodiments, the device (and, therefore, the reticulated foam material) possesses a thickness of from at least about 0.3 centimeters (cm) to no greater than about 30 cm, although certain embodiments may include devices and/or reticulated foam materials having a thickness outside of this range. In various embodiments, the reticulated foam material may have a thickness of at least about 0.3 cm, at least about 0.53 cm, at least about 0.8 cm, at least about 1.0 cm, at least about 1.12 cm, at least about 2.2 cm, at least about 2.34 cm at least about 5.0 cm, or at least about 10 cm. In various embodiments, the reticulated foam material may have a thickness of no greater than about 10 cm, no greater than about 7.5 cm, no greater than about 2.74 cm, no greater than about 2.5 cm, no greater than about 1.42 cm, no greater than about 1.3 cm, no greater than about 0.73 cm, or no greater than about 0.7 cm. Thus, in one embodiment, the reticulated foam material has a thickness of at least about 0.53 cm and no greater than about 0.73 cm. In another particular embodiment, the reticulated foam has a thickness of from about 1.12 cm to about 1.42 cm. In yet another particular embodiment, the reticulated foam has a thickness of from about 2.34 cm to about 2.74 cm.

In other embodiments, the contact surface may include an area of reticulated foam disposed on a portion of a core structure. In such embodiments, the thickness of the reticulated foam may be from at least about 0.1 cm to no greater than about 10 cm, although certain embodiments of the device may have a contact surface constructed from a reticulated foam material having a thickness outside this range. In certain embodiments, the reticulated foam material may have a thickness of at least about 0.2 cm to no greater than 1.5 cm.

In embodiments where the trough is constructed from a reticulated foam material, the trough may be formed using any suitable technique. Suitable techniques include, for example, rotary or rule die cutting and ultrasonic welding.

In another aspect, the invention includes methods of applying a dental agent to the dentition of a subject. Generally, the methods include providing a dental applicator device that includes a trough comprising a first wall, a second wall, and a floor, wherein at least one of the first wall, second wall, and floor comprises a contact surface, and wherein at least a portion of the contact surface comprises a reticulated foam material, and a dental agent disposed in at least a portion of the trough; applying the dental applicator device to at least a portion of the subject's dentition for a time effective to transfer an effective amount of the dental agent to at least a portion of the target surface; and removing the dental applicator device.

In some embodiments, the time effective to transfer an effective amount of the dental agent to at least a portion of the target surface may be at least about one second and no greater than about ten minutes.

The method permits application of a controlled dose of dental agent while limiting the likelihood and extent to which excess dental agent is permitted to escape the applicator device and be deposited in the subject's oral cavity. The thickness of the coating applied to the dentition of the subject may be controlled by the size of the pores (or cells) of the reticulated foam. Generally, a larger pore size provides a thicker coating and a smaller pore size provides a thinner coating.

In certain embodiments of the method, dentition from both dental arches may be treated. Such embodiments may employ two devices—one for each dental arch or portion thereof. In other embodiments, the device may include a second trough configured to receive teeth from the subject's second dental arch and dispense dental agent to one or more target surfaces of the second dental arch. In embodiments where both dental arches receive dental agent, a different dental agent may be applied each dental arch or, alternatively, the same dental agent may be applied to both dental arches.

Suitable subjects include any animal, including humans, having dentition. Thus, in some embodiments, the subject may be a human. In certain specific embodiments, the human may be a child while in other embodiments, the human may be an adult. Other suitable subjects include, for example, companion animals (e.g., dogs, cats, etc.), livestock animals (e.g., cows, horses, goats, sheep, etc.), and exotic animals (e.g., zebra, giraffes, elephants, etc.).

In another aspect, the invention provides kits for providing dental treatment. Generally, the kits include a dental treatment applicator device, as described above, and a dental agent. The kits may include a single applicator device or two devices. Similarly, the kits may include a single dental agent or a plurality of agents. The kit may include dental agent preloaded on the device so that a user need only open the kit packaging and the device is ready for use. Alternatively, the kit may include the dental agent provided in a container. The kit may optionally further include some tool (e.g., brush, spatula, container nozzle, etc.) that permits or assists the user in adding dental agent to the device.

The complete disclosures of all patents, patent applications, and publications that are cited herein are hereby incorporated by reference as if individually incorporated. Various modifications and alterations of this invention will become apparent to those skilled in the art without departing from the scope and spirit of this invention, and it should be understood that this invention is not to be unduly limited to the illustrative embodiments set forth herein.

1. A dental applicator device comprising:
a trough comprising a first wall, a second wall, and a floor, wherein at least one of the first wall, second wall, and floor comprises a contact surface, wherein at least a portion of the contact surface comprises a reticulated foam material.

2-3. (canceled)

4. The dental application device of claim 1 comprising a core structure comprising an orally safe base material, wherein the contact surface comprises a layer of reticulated foam material disposed on at least a portion of the core structure.

5. The dental application device of claim 1 wherein the trough is configured to fit a dental arch of an animal.

6. The dental application device of claim 5 wherein the animal is a human.

7-9. (canceled)

10. The dental application device of claim 1 having a thickness of at least about 0.3 cm and no greater than about 10 cm.

11. The dental application device of claim 10 having a thickness of at least about 0.3 cm and no greater than about 0.7 cm.

12. The dental application device of claim 10 having a thickness of at least about 0.8 cm and no greater than about 1.3 cm.

13. The dental application device of claim 10 having a thickness of at least about 1.0 cm and no greater than about 2.5 cm.

14. The dental application device of claim 10 having a thickness of at least about 2.2 cm and no greater than about 10 cm.

15. The dental application device of claim 14 having a thickness of at least about 5.0 cm and no greater than about 7.5 cm.

16. The dental application device of claim 14 further comprising a dental agent.

17. A method of applying a dental agent to the dentition of a subject, the method comprising:
providing a dental applicator device comprising:
a trough comprising a first wall, a second wall, and a floor, wherein at least one of the first wall, second wall, and floor comprises a contact surface, wherein at least a portion of the contact surface comprises a reticulated foam material, and
a dental agent disposed in at least a portion of the trough;
applying the dental applicator device to at least a portion of the subject's dentition for a time effective to transfer an effective amount of the dental agent to at least a portion of the target surface; and
removing the dental applicator device.

18. The method of claim 17 wherein the dental agent comprises a fluoride source, an antimicrobial agent, an antifungal agent, a biologically active material, an oxygenating agent, a bleach, a whitener, an anticaries agent, a remineralizing agent, an agent for treating xerostomia, an anesthetic, a desensitizing agent, a clotting agent, a wetting agent, a breath freshener, a varnish, a polish, or any combination thereof.

19. The method of claim 17 wherein the time effective to transfer an effective amount of the dental agent to at least a portion of the target surface is from about one second to about ten minutes.

20-22. (canceled)

23. The method of claim 17 wherein the portion of the subject's dentition comprises one dental arch.

24. A method of applying a dental agent to the dentition of a subject, the method comprising:
providing a dental applicator device comprising:
a first trough comprising a first wall, a second wall, and a floor, wherein at least one of the first wall, second wall, and floor comprises a first contact surface, wherein at least a portion of the first contact surface comprises a reticulated foam material,
a first dental agent disposed in at least a portion of the first trough;
a second trough comprising a first wall, a second wall, and a floor, wherein at least one of the first wall, second wall, and floor comprises a second contact surface, wherein at least a portion of the second contact surface comprises a reticulated foam material, and
a second dental agent disposed in at least a portion of the second trough;
applying the dental applicator device to at least a portion of the subject's dentition,
wherein the first trough contacts at least a portion of a subject's first dental arch comprising a first target surface, and the second trough contacts at least a portion of the subject's second dental arch comprising a second target surface, and
wherein the dental applicator device is applied for a time effective to transfer an effective amount of the first dental agent to at least a portion of the first target surface and to transfer an effective amount of the second dental agent to at least a portion of the second target surface; and
removing the dental applicator device.

25. The method of claim 24, wherein providing a dental applicator device includes:
providing a first dental applicator device comprising the
first trough and
the first dental agent; and
providing a second dental applicator device comprising
the second trough
the second dental agent.

26. The method of claim 24 wherein the first dental agent or the second dental agent comprises a fluoride source, an antimicrobial agent, an antifungal agent, a biologically active material, an oxygenating agent, a bleach, a whitener, an anticaries agent, a remineralizing agent, an agent for treating xerostomia, an anesthetic, a desensitizing agent, a clotting agent, a wetting agent, a breath freshener, a varnish, a polish, or any combination thereof.

27. The method of claim 24 wherein the first dental agent and the second dental agent comprise the same material.

28. The method of claim 24 wherein the first dental agent and the second dental agent comprise different materials.

29. The method of claim 24 wherein the time that the dental applicator device is applied is from about one second to about ten minutes.

30. The method of claim 25 wherein the first dental applicator device and the second dental applicator device are applied to at least a portion of the subject's dentition simultaneously.

31. The method of claim 25 wherein the first dental applicator device and the second dental applicator device are applied to at least a portion of the subject's dentition sequentially.

32. The method of claim wherein the time effective to transfer an effective amount of at least one of the first dental agent and the second dental agent to at least a portion of at least one of the first target surface and the second target surface is from about one second to about ten minutes.

33-38. (canceled)

39. A kit comprising:
The dental applicator device of claim 1, wherein the trough is one of a plurality of troughs; and
at least one dental agent.

40. The kit of claim 39 wherein the at least one dental agent comprises a fluoride source, an antimicrobial agent, an antifungal agent, a biologically active material, an oxygenating agent, a bleach, a whitener, an anticaries agent, a remineralizing agent, an agent for treating xerostomia, an anesthetic, a desensitizing agent, a clotting agent, a wetting agent, a breath freshener, a varnish, a polish, or any combination thereof.

41-42. (canceled)
